(19) United States
(12) Patent Application Publication
(10) Pub. No.: US 2011/0121755 A1
(43) Pub. Date: May 26, 2011

(54) METHOD OF CONTROLLING SUPPLY VOLTAGE, MULTI-CHANNEL LIGHT-EMITTING DIODE DRIVING CIRCUIT AND MULTI-CHANNEL SYSTEM USING THE SAME

(75) Inventor: Hee-seok HAN, Hwaseong-si (KR)

(73) Assignee: SAMSUNG ELECTRONICS CO., LTD., Suwon-si (KR)

(21) Appl. No.: 12/941,607

(22) Filed: Nov. 8, 2010

(30) Foreign Application Priority Data
Nov. 24, 2009 (KR) 10-2009-0114057

(51) Int. Cl. H05B 37/02

(52) U.S. Cl. 315/294

(57) ABSTRACT

Provided is a multi-channel LED driving circuit which includes: an LED array of N LED channels (N is an integer equal to or greater than one), each channel having a plurality of LEDs connected in series, a supply voltage being input to one end of each channel, and the other end of each channel being connected to N current drivers, respectively; a dynamic headroom control block comparing N channel voltages of common nodes of the N LED channels and the N current drivers with combination voltages of a first reference voltage and a hysteresis voltage, and generating a second reference voltage in response to at least one dimming signal that defines a time period during which a predetermined current flows to the N current drivers through the N LED channels; and a direct current to direct current (DC-DC) converter generating the supply voltage corresponding to the second reference voltage.

### CROSS-REFERENCE TO RELATED APPLICATIONS

This application claims priority from Korean Patent Application No. 10-2009-0114057, filed on Nov. 24, 2009, in the Korean Intellectual Property Office, the disclosure of which is incorporated herein in its entirety by reference.

### BACKGROUND

Apparatuses and methods consistent with exemplary embodiments relate to a light-emitting diode (LED) driving circuit, and more particularly, to a multi-channel LED driving circuit for implementing a dynamic headroom control method to supply a most suitable voltage to each channel including a LED string having a plurality of LEDs connected in series.

Recently, a technique of using a LED as a backlight unit that supplies light to the background of a liquid crystal display (LCD) has been spotlighted because the LED has low power consumption, and products including the LCD can be designed slim when the LED is used as a backlight unit.

When the LED is used for a backlight unit of a large display such as a notebook computer, television receiver, etc., a plurality of LED strings respectively including a plurality of LEDs connected in series are used to provide backlight to a large-area display. If a single string corresponds to a single channel, a plurality of strings are referred to as multi-channel. An additional driving circuit is used to drive the LEDs. It is required to actively control a supply voltage to supply a most suitable voltage to each channel of multi-channel LEDs.

### SUMMARY

One or more exemplary embodiments provide a multi-channel light-emitting diode (LED) driving circuit which controls a supply voltage in a digital manner while minimizing the influence of noise.

One or more exemplary embodiments also provide a supply voltage controlling method for controlling a supply voltage in a digital manner while minimizing the influence of noise.

One or more exemplary embodiments also provide a multi-channel system which implements a supply voltage controlling method for controlling a supply voltage in a digital manner while minimizing the influence of noise.

According to an aspect of an exemplary embodiment, there is provided a multi-channel LED driving circuit including an LED array, a current driving block, dynamic headroom control block, and a DC-DC converter. The LED array includes N LED channels (N is an integer equal to or greater than one (1)), each of which includes a plurality of LEDs connected in series, to one end of each of which a supply voltage is input, and the other end of which is connected to N current drivers, respectively. The dynamic headroom control block compares N channel voltages of common nodes of the N LED channels and the N current drivers with combination voltages of a first reference voltage and a hysteresis voltage, and generates a second reference voltage in response to at least one dimming signal that defines a time period during which a predetermined current flows to the N current drivers through the N LED channels. The DC-DC converter generates the supply voltage corresponding to the second reference voltage.

According to an aspect of another exemplary embodiment, there is provided a method for controlling a supply voltage, which is applied to a multi-channel LED driving circuit including N LED channels (N is an integer equal to or greater than one (1)), each of which includes a plurality of LEDs connected in series, to one end of which a supply voltage in input, and the other end of which is connected to N current drivers, respectively. The method includes deciding a first reference voltage and a hysteresis voltage and receiving N channel voltages of common nodes of N LED channels and the N current drivers corresponding to the N LED channels, respectively, comparing the N channel voltages with a first combination voltage defined as a sum of the first reference voltage and the hysteresis voltage and a second combination voltage defined as a difference between the first reference voltage and the hysteresis voltage, maintaining, increasing or decreasing the supply voltage according to a result of the comparing.

According to an aspect of another exemplary embodiment, there is provided a multi-channel system employing the above method for controlling a supply voltage.

### BRIEF DESCRIPTION OF THE DRAWINGS

Exemplary embodiments will be more clearly understood from the following detailed description taken in conjunction with the accompanying drawings, in which:

FIG. 1 illustrates a multi-channel light-emitting diode (LED) driving circuit according to an exemplary embodiment;

FIG. 2 is a circuit diagram of a 1.5 bit analog-to-digital converter shown in FIG. 1, according to an exemplary embodiment;

FIG. 3 is a block diagram of a delayed latch block shown in FIG. 1, according to an exemplary embodiment;

FIG. 4 is a circuit diagram of a digital compensation block shown in FIG. 1, according to an exemplary embodiment;

FIG. 5 is a circuit diagram of the digital compensation block including a memory & selection unit, according to an exemplary embodiment;

FIG. 6 is a circuit diagram of one of a plurality of current drivers constituting a current driving block shown in FIG. 1, according to an exemplary embodiment;

FIG. 7 is a flowchart showing a supply voltage controlling method performed by the multi-channel LED driving circuit, according to an exemplary embodiment;

FIG. 8 is a waveform diagram of a first dimming signal D1, a first compare signal H1, and a delayed latch signal D_H1, according to an exemplary embodiment;

FIG. 9 is a waveform diagram of a current level change signal CLCS, a second reference voltage VREF2, a supply voltage VOUT, and a current I_{LED} flowing through the LEDs when the digital compensation block 122 does not include the memory & selection unit 550, according to an exemplary embodiment;

FIG. 10 is a waveform diagram showing the current level change signal CLCS, the second reference voltage VREF2, the supply voltage VOUT, and the current I_{LED} flowing through the LEDs when the digital compensation block 122 includes the memory & selection unit 550, according to an exemplary embodiment;

FIGS. 11 and 12 illustrate the relationship between the dimming voltage signals DS1 to DSN, according to an exemplary embodiment;

FIG. 13 illustrates an edge type LCD according to an exemplary embodiment; and

FIG. 14 illustrates a direct type LCD according to an exemplary embodiment.

### DETAILED DESCRIPTION OF EXEMPLARY EMBODIMENTS

Hereinafter, exemplary embodiments will be described in detail with reference to the attached drawings. Like reference numerals in the drawings denote like elements.

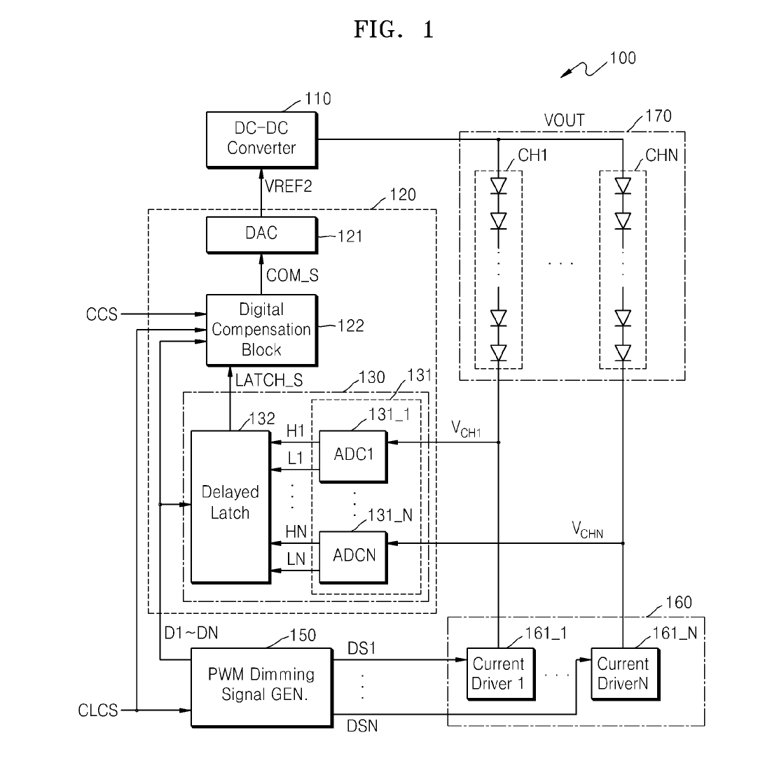

FIG. 1 illustrates a multi-channel light-emitting diode (LED) driving circuit 100 according to an exemplary embodiment.

Referring to FIG. 1, the multi-channel LED driving circuit 100 includes a direct current to direct current (DC-DC) converter 110, a dynamic headroom control block 120, a pulse width modulation (PWM) dimming signal generator 150, a current driving block 160, and an LED array 170.

The current driving block 160 includes N (N is an integer equal to or greater than one) current drivers 161_1 through 161_N which respectively generate corresponding currents for time durations corresponding to dimming voltage signals DS1 through DSN output from the PWM dimming signal generator 150.

The LED array 170 includes N LED channels CH1 through CHN respectively having a plurality of LEDs connected in series. First terminals of the N LED channels CH1 through CHN are connected to an output of the DC-DC converter 110 which provides a supply voltage VOUT to each of the N LED channels CH1 through CHN, and second terminals thereof are respectively connected to the N current drivers 161_1 through 161_N constituting the current driving block 160.

Since the N LED channels CH1 through CHN have the same number of LEDs connected in series, which have the same electrical standard, uniform current flows through each of the N LED channels CH1 through CHN disposed between the output of the DC-DC converter 110, from which the supply voltage VOUT is output, and the N current drivers 161_1 through 161_N. Accordingly, channel voltages V_{CH1} through V_{CHN} of common nodes of the last LEDs of the N LED channels CH1 through CHN and the N current drivers 161_1 through 161_N have the same value. However, LEDs produced through the same manufacturing process may not have the same electrical property, and instead may have a slight difference in the electrical property. Accordingly, there may be a difference in the power consumed by the N LED channels CH1 through CHN respectively including a plurality of LEDs connected in series. When the voltages of the common nodes of the last LEDs of the N LED channels CH1 through CHN and the N current drivers 161_1 through 161_N are defined as the channel voltages V_{CH1} through V_{CHN}, the N channel voltages V_{CH1} through V_{CHN} may have different values due to the electrical property difference among the LEDs.

Exemplary embodiments propose a method and an apparatus for controlling the N channel voltages V_{CH1} through V_{CHN} when the channel voltages V_{CH1} through V_{CHN} become higher or lower than a predetermined reference voltage. According to an exemplary embodiment, two combination voltages generated by combining a first reference voltage VREF1 and a hysteresis voltage VHYS, which will be explained in detail later, are used.

The PWM dimming signal generator 150 generates dimming signals D1 through DN corresponding to time periods of the dimming voltage signals DS1 through DSN supplied to the current driving block 160. The dimming signals D1 through DN include information regarding the enable time of the N current drivers 161_1 through 161_N, whereas the dimming voltage signals DS1 through DSN determine the magnitude of current and the enable time of the N current drivers 161_1 through 161_N corresponding thereto. Accordingly, the dimming voltage signals DS1 through DSN and the dimming signals D1 through DN may be selectively used individually or used together. The dimming voltage signals DS1 through DSN may have the same phase or have a specific delay difference in their phases, which will be described later. When current flowing through the LEDs is required to change, the PWM dimming signal generator 150 further receives a current level change signal CLCS to vary the dimming voltage signals DS1 through DSN, which will be explained in detail later.

The DC-DC converter 110 generates the supply voltage VOUT in response to a second reference voltage VREF2 output from the dynamic headroom control block 120, and provides the supply voltage VOUT to the LED array 170. The second reference voltage VREF2 and the supply voltage VOUT are DC voltages.

The dynamic headroom control block 120 compares the N channel voltages V_{CH1} through V_{CHN} with the combination voltages of the first reference voltage VREF1 and the hysteresis voltage VHYS, and generates the second reference voltage VREF2 corresponding to the comparison result, in response to at least one dimming signal D1 through DN. To achieve this, the dynamic headroom control block 120 includes a compare block 130, a digital compensation block 122 and a digital-to-analog converter 121.

The compare block 130 compares the N channel voltages V_{CH1} through V_{CHN} with the combination voltages, and delays the comparison results by a predetermined time in response to the corresponding dimming signal to generate a delayed latch signal LATCH_S. The digital compensation block 122 compensates for the delayed latch signal LATCH_S, according to the logic state of the delayed latch signal LATCH_S, in response to the corresponding dimming signal, to generate a compensated signal COM_S. Here, the N channel voltages V_{CH1} through V_{CHN} and the combination voltages are analog voltages, which are converted into digital signals by the compare block 130. The digital signals are processed by the digital compensation block 122. The digital-to-analog converter 121 converts the compensated signal COM_S corresponding to a digital signal to generate the second reference voltage VREF2 corresponding to an analog signal.

The compare block 130 includes an analog-to-digital converter block 131 and a delayed latch block 132.

The analog-to-digital converter block 131 compares the N analog channel voltages V_{CH1} through V_{CHN} with the analog combination voltages, and generates 2N digital compare signals, namely, first compare signals H1 through HN and second compare signals L1 through LN. The analog-to-digital converter block 131 includes N 1.5 bit analog-to-digital converters 131_1 through 131_N which respectively compare the N channel voltages V_{CH1} through V_{CHN} with the combination voltages to generate first compare signals H1 through HN and second compare signals L1 through LN. The delayed latch block 132 delays the 2N compare signals, namely, the first compare signals H1 through HN and the second compare signals L1 through LN in response to the dimming signals D1 through DN to generate the delayed latch signal LATCH_S.

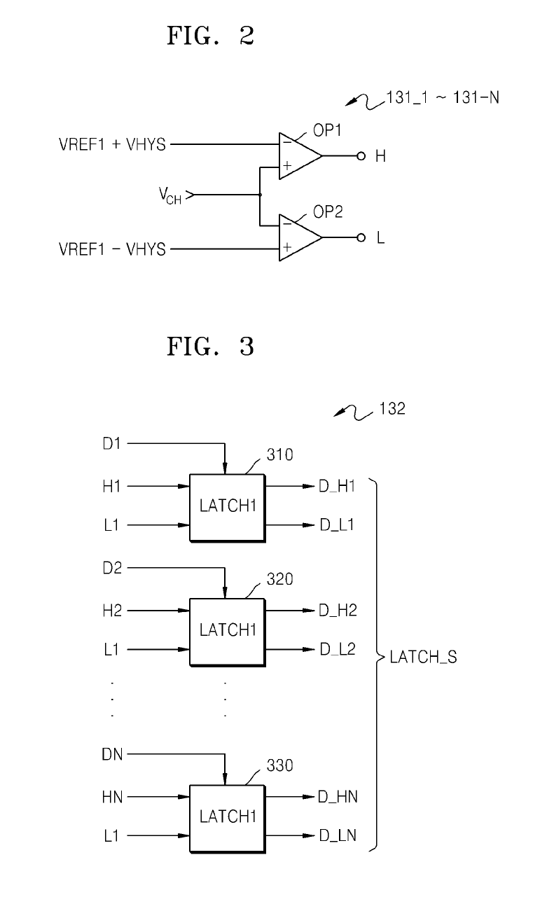

FIG. 2 is a circuit diagram of one of the N 1.5 bit analog-to-digital converters 131_1 through 131_N shown in FIG. 1, according to an exemplary embodiment.

Referring to FIG. 2, the 1.5 bit analog-to-digital converter includes a first comparator OP1 and a second comparator OP2. The first comparator OP1 generates the first compare signal H corresponding to a difference between a first combination voltage VREF1+VHYS corresponding to the sum of the first reference voltage VREF1 and the hysteresis voltage VHYS, which is applied to a negative input terminal thereof, and the corresponding channel voltage V_{CH1} applied to a positive input terminal thereof. The second comparator OP2 generates the second compare signal L corresponding to a difference between a second combination voltage VREF1−VHYS corresponding to a difference between the first reference voltage VREF1 and the hysteresis voltage VHYS, which is applied to a positive input terminal thereof, and the corresponding channel voltage V_{CH} applied to a negative input terminal thereof.

The logic states of the first compare signal H and the second compare signal L are determined under the following condition.

If the channel voltage V_{CH} is higher than the first combination voltage VREF1+VHYS, the first compare signal H output from the 1.5 bit analog-to-digital converter is logic high.

If the channel voltage V_{CH} is lower than the second combination voltage VREF1−VHYS, the second compare signal L output from the 1.5 bit analog-to-digital converter is logic high.

If the channel voltage V_{CH} corresponds to a value between the first combination voltage VREF1+VHYS and the second combination voltage VREF1−VHYS, both the first compare signal H and the second compare signal L output from the 1.5 bit analog-to-digital converter are logic low.

Since there are N LED channels, 2N compare signals, namely, the first compare signals H1 through HN and the second compare signals L1 through LN are output from the analog-to-digital converter block 131.

FIG. 3 is a block diagram of the delayed latch block 132 shown in FIG. 1, according to an exemplary embodiment.

Referring to FIG. 3, the delayed latch block 132 includes N delayed latch circuits 310 through 330.

The first delayed latch circuit 310 delays the first compare signal H1 and the second compare signal L1 output from the first analog-to-digital converter 131_1 by a predetermined time to generate a first latch signal D_H1 and a second latch signal D_L1 in response to the first dimming signal D1.

The second delayed latch circuit 320 delays the first compare signal H2 and the second compare signal L2 output from the second analog-to-digital converter (not shown) by a predetermined time to generate a first latch signal D_H2 and a second latch signal D_L2 in response to the second dimming signal D2.

The Nth delayed latch circuit 330 delays the first compare signal FIN and the second compare signal LN output from the Nth analog-to-digital converter 131_N by a predetermined time to generate a first latch signal D_HN and a second latch signal D_LN in response to the Nth dimming signal DN.

For convenience of explanation, all the compare signals, namely, the first and second latch signals D_H1, D_L1, D_H2, D_L2, . . . , D_HN, D_LN output from the first through Nth delayed latch circuits 310 through 330 are referred to as the delayed latch signal LATCH_S.

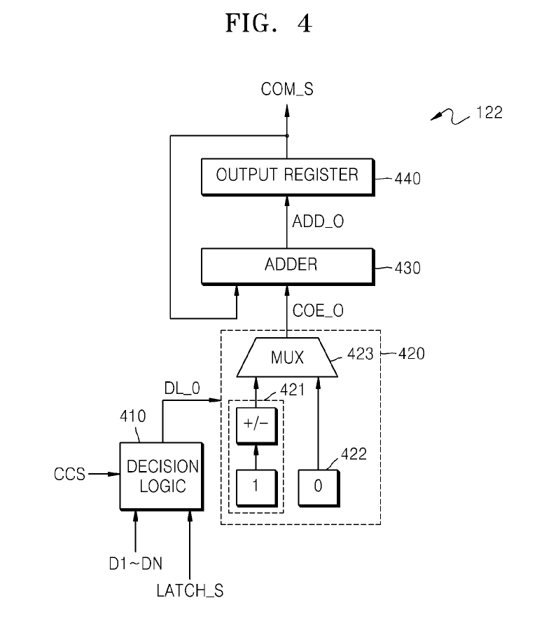

FIG. 4 is a circuit diagram of the digital compensation block 122 shown in FIG. 1, according to an exemplary embodiment.

Referring to FIG. 4, the digital compensation block 122 includes a decision logic circuit 410, a coefficient decision unit 420, an adder 430 and an output register 440.

The decision logic circuit 410 generates a compensation decision signal DL_O using the dimming signals D1 through DN and the delayed latch signal LATCH_S. The coefficient decision unit 420 generates a coefficient signal COE_O corresponding to the compensation decision signal DL_O. The adder 430 adds the coefficient signal COE_O to the compensated signal COM_S. The output register 440 stores a signal ADD_O output from the adder 430 and outputs a compensated signal COM_S.

The compensation decision signal DL_O includes information that instructs the coefficient signal COE_O generated by the coefficient decision unit 420 to be minus one (−1) if all the first compare signals H1 through HN output from the delayed latch circuits are logic high. The compensation decision signal DL_O includes information that instructs the coefficient signal COE_O to be one (1) if at least one of the second compare signals L1 through LN output from the delayed latch circuits is logic high. The compensation decision signal DL_O includes information that instructs the coefficient signal COE_O to be 0 in the other cases.

The compensation decision signal DL_O is output according to the cycle of the dimming signals D1 through DN.

The multi-channel LED driving circuit 100 according to the exemplary embodiment may change a compensation cycle.

When a compensation control signal CCS having information regarding the compensation cycle is applied to the decision logic circuit 410, the cycle of generation of the compensation decision signal DL_O is controlled according to the cycle of the dimming signals D1 through DN, in response to the compensation control signal CCS. For example, the compensation decision signal DL_O may be generated in a single period of the dimming signals D1 through DN or generated in two or more periods of the dimming signals D1 through DL.

The coefficient decision unit 420 includes a first coefficient generating unit 421, a second coefficient storing unit 422, and a first multiplexer 423.

The first coefficient generating unit 421 includes a first coefficient storing unit for storing coefficient 1 and a sign selecting unit for selecting the sign of coefficient 1 in response to the compensation decision signal DL_O. The second coefficient storing unit 422 stores coefficient zero (0). The first multiplexer 423 selects one of the coefficients output from the first coefficient generating unit 421 and the second coefficient storing unit 422, and outputs the selected coefficient in response to the compensation decision signal DL_O.

The multi-channel LED driving circuit 100 according to the exemplary embodiment may further include a memory & selection unit 550 for allowing current supplied to the LEDs to rapidly vary even when the multi-channel LED driving circuit drives the LEDs while varying the current flowing through the LEDs.

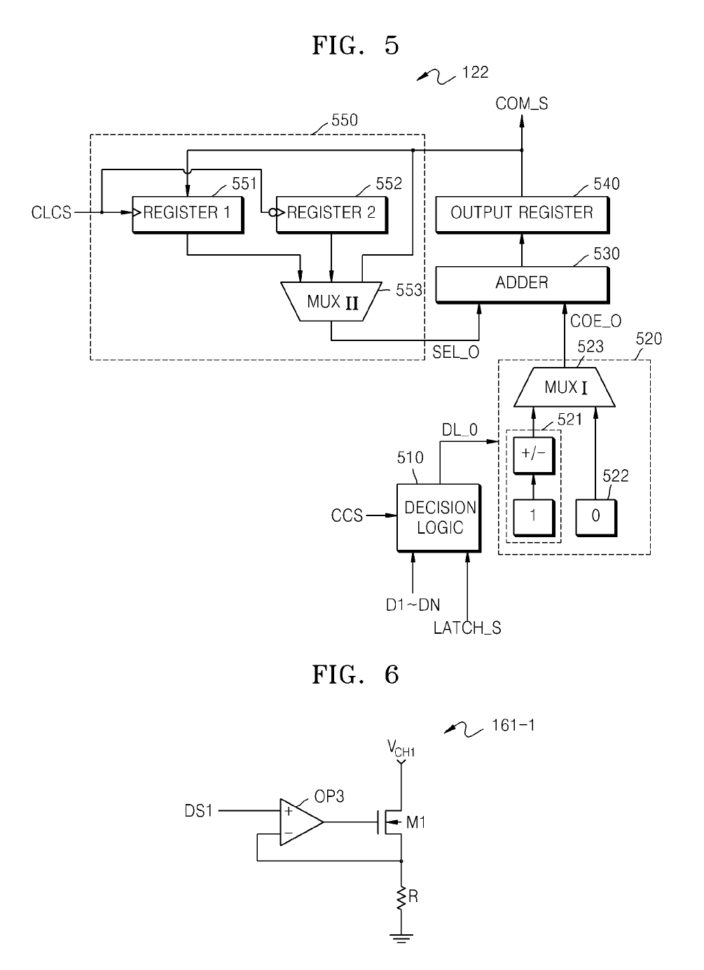

FIG. 5 is a circuit diagram of the digital compensation block 122 further including the memory & selection unit 550, according to an exemplary embodiment.

The following description is given under the assumption that current varies between two levels for convenience of explanation.

The digital compensation block 122 shown in FIG. 5 further includes the memory & selection unit 550, in addition to the components of the digital compensation block 122 shown in FIG. 4. Functions and operations of the components of the digital compensation block 122 shown in FIG. 5, other than the memory & selection unit 550, are identical to those of the components of the digital compensation block 122 shown in FIG. 4, and thus, only the memory & selection unit 550 and electrical connections related to the memory & selection unit 550 will be explained.

The current level change signal CLCS, which will be described in detail later, determines the level of current flowing through the LEDs.

The memory & selection unit 550 stores the compensated signal COM_S output from the output register 540, in response to the current level change signal CLCS, and transmits to the adder 530 a selected compensated signal SEL_O selected from the stored compensated signal COM_S and the compensated signal COM_S directly output from the output register 540. To achieve this, the memory & selection unit 550 includes a first register 551, a second register 552 and a multiplexer 553.

The first register 551 stores a compensated signal COM_S corresponding to a first current level signal among compensation signals COM_S output from the output register 540, in response to the current level change signal CLCS. The second register 552 stores a compensated signal COM_S corresponding to a second current level signal among the compensated signals COM_S output from the output register 540 in response to the current level change signal CLCS. The multiplexer 553 selects one of the compensated signal stored in the first register 551, the compensated signal stored in the second register 553, and the compensated signal COM_S directly output from the output register 540 as the selected compensated signal SEL_O, in response to the current level change signal CLCS. A method of using the signals stored in the first and second registers 551 and 552 will be explained later.

FIG. 6 is a circuit diagram of one of the current drivers 161_1 through 161_N of the current driving block 160 shown in FIG. 1, according to an exemplary embodiment.

Only the first current driver 161_1 among the N current drivers 161_1 through 161_N is described for convenience of explanation.

Referring to FIG. 6, the first current driver 161_1 may include a differential operational amplifier OP3, a metal-oxide-semiconductor (MOS) transistor M1, and a resistor R. The differential operational amplifier OP3 receives the first dimming voltage signal through a positive input terminal thereof. The MOS transistor M1 has a first terminal connected to the first channel voltage V_{CH1}, a second terminal connected to a negative input terminal of the differential operational amplifier OP3, and a gate receiving the output signal of the differential operational amplifier OP3. A first terminal of the resistor R is connected to an input terminal of the differential operational amplifier OP3 and the second terminal of the MOS transistor, and a second terminal of the resistor R is grounded.

The operation of the first current driver 161_1 shown in FIG. 6 is well known in the art so the operation will be roughly described.

When the first dimming voltage signal DS_1 is applied to the positive input terminal of the differential operational amplifier OP3, the output voltage of the differential operational amplifier OP3 increases, and thus, a large magnitude of current is supplied from the MOS transistor M1 to the resistor R. To deliver a sufficient amount of current flowing from the MOS transistor M1 to the ground voltage through the resistor R, the voltage of the common node at which the MOS transistor M1 and the resistor R is connected is required to be increased. When the voltage of the common node increases, the voltage of the negative input terminal of the differential operational amplifier OP3 also increases. Consequently, the differential operational amplifier OP3 operates as an analog buffer circuit, and thus the current flowing through the resistor R is determined by the first dimming voltage signal DS1.

The configuration of the multi-channel LED driving circuit 100 according to an exemplary embodiment has been described with reference to FIGS. 1 through 6. The operation characteristics of the multi-channel LED driving circuit 100 will now be explained in more detail.

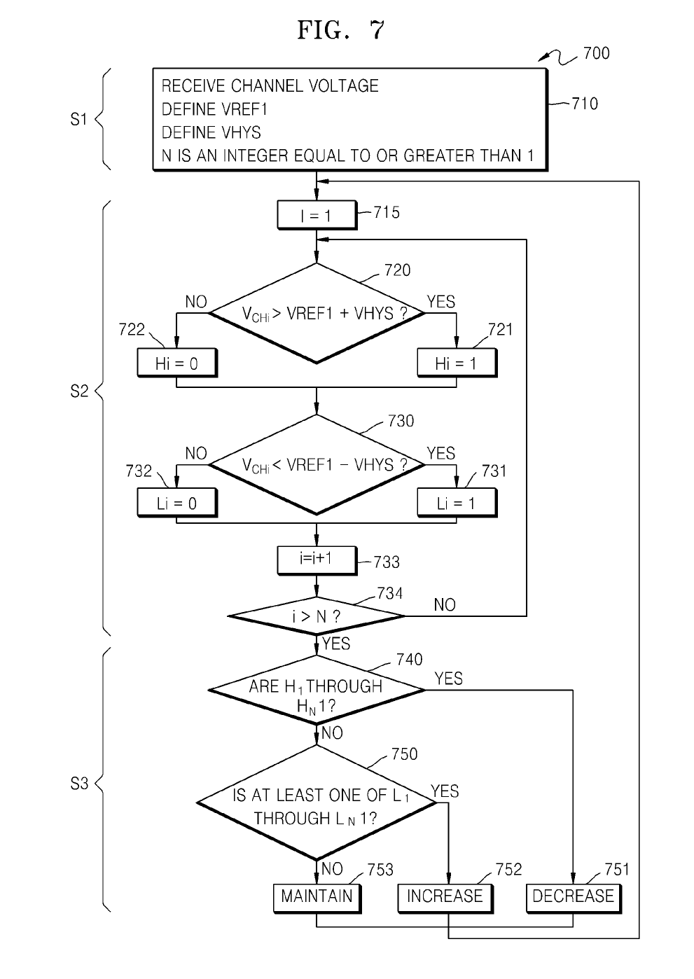

FIG. 7 is a flowchart showing a supply voltage controlling method performed by the multi-channel LED driving circuit 100, according to an exemplary embodiment.

Referring to FIG. 7, the supply voltage controlling method is implemented in the multi-channel LED driving circuit 100 shown in FIG. 1, which includes the N LED channels CH1 through CHN respectively having the plurality of LEDs connected in series between the supply voltage VOUT and the N current drivers 161_1 through 161_N. The supply voltage controlling method includes an initial operation S1, a comparison operation S2, and a voltage control operation S3.

In the initial operation S1, the first reference voltage and the hysteresis voltage VHYS are determined, and the N channel voltages V_{CH1} through V_{CHN} of the common nodes between the N LED channels and the N current drivers 161_1 through 161_N corresponding to the N LED channels are received. In the comparison operation S2, the N channel voltages V_{CH1} through V_{CHN} are compared with the first combination voltage VREF1+VHYS corresponding to the sum of the first reference voltage VREF1 and the hysteresis voltage VHYS and the second combination voltage VREF1−VHYS corresponding to a difference between the first reference voltage VREF1 and the hysteresis voltage VHYS. In the voltage control operation S3, the supply voltage VOUT is maintained, increased or decreased according to the comparison results of the comparison operation S2.

The comparison operation S2 and the voltage control operation S3 will now be explained in detail.

The comparison operation S2 includes a first determination operation 720, first compare signal assign operations 721 and 722, a second determination operation 730 and second compare signal assign operations 731 and 732.

The first determination operation 720 determines whether the N channel voltages V_{CH1} through V_{CHN} are higher than the first combination voltage VREF1+VHYS. The first compare signal assign operation 721 assigns logic high to the first compare signal if the N channel voltages V_{CH1} through V_{CHN} are higher than the first combination voltage VREF1+VHYS, and the first compare signal assign operation 722 assigns logic low to the first compare signal if the N channel voltages V_{CH1} through V_{CHN} are lower than the first combination voltage VREF1+VHYS.

The second determination operation 730 determines whether the N channel voltages V_{CH1} through V_{CHN} are lower than the second combination voltage VREF1−VHYS. The second compare signal assign operation 731 assigns logic high to the second compare signal if the N channel voltages V_{CH1} through V_{CHN} are lower than the second combination voltage VREF1−VHYS, and the second compare signal assign operation 732 assigns logic low to the second compare signal if the N channel voltages V_{CH1} through V_{CHN} are higher than the second combination voltage VREF1−VHYS.

The supply voltage controlling method further includes a variable setting operation 715, a variable increasing operation 733 and a variable comparison operation 734 to perform the operations 720, 721, 722, 730, 731, and 732 on all the N channel voltages V_{CH1} through V_{CHN}. Here, i is a variable.

In the variable setting operation 715, a first variable is set to one (1), and the operations 720, 721, 722, 730, 731, and 732 are performed on a channel voltage corresponding to the first variable (i=1). Then, the variable i is increased by one in the variable increasing operation 733 and the operations 720, 721, 722, 730, 731 and 732 are carried out on the next channel voltage. These operations are repeated until it is determined in a variable comparison operation 734 that the variable i exceeds a predetermined value N.

The voltage control operation S3 includes a third determination operation 740, a fourth determination operation 750, and supply voltage compensation operations 751, 752, and 753.

The third determination operation 740 determines whether all the N first compare signals H1 through FIN are one (1). The fourth determination operation 750 determines whether at least one of the N second compare signals L1 through LN is one (1). The supply voltage compensation operation 751 decreases the supply voltage VOUT if all the N first compare signals H1 through HN are one (1), and the supply voltage compensation operation 752 increases the supply voltage VOUT if at least one of the N second compare signals L1 through LN is one (1). The supply voltage compensation operation 753 maintains the current supply voltage VOUT in the other cases.

After the supply voltage compensation operations 751, 752, and 753, the initial operation S1, the comparison operation S2 and the voltage control operation S3 may be repeated.

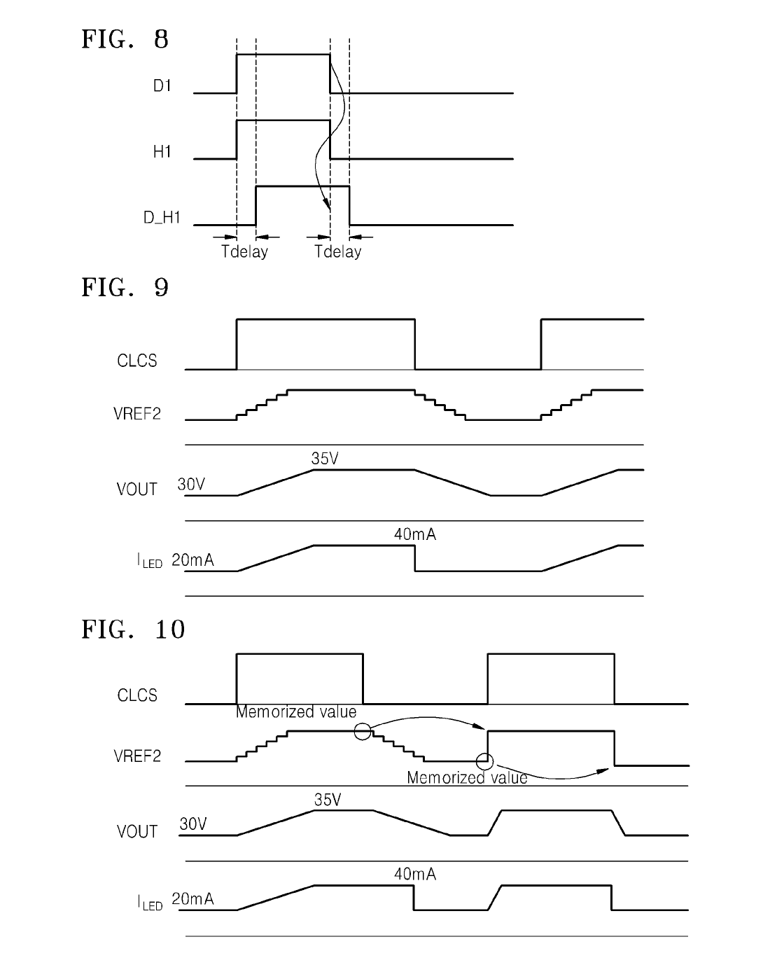

FIG. 8 is a waveform diagram of the first dimming signal D1, the first compare signal H1, and the delayed latch signal D_H1.

Referring to FIG. 8, the first compare signal H1 is output when the dimming signal D1 is logic high, and the first compare signal H1 is disabled when the dimming signal D1 transits to logic low. Since the respective LED channels have different points of time, at which the dimming signals D1 through DN are turned on, and different periods of time in which a turn-on state of the dimming signals D1 through DN is maintained, the voltage state of each channel may not be correctly read if the first compare signal H1 is used without being changed. Accordingly, the exemplary embodiment uses the delayed latch signal D_H1 obtained by delaying the first compare signal H1 by a predetermined time Tdelay.

Referring to FIG. 8, it can be seen that the logic state of the delayed latch signal D_H1 at a falling edge of the dimming signal D1 is correctly recognized although the logic state of the first compare signal H1 at the falling edge of the dimming signal D1 may not be correctly recognized.

FIG. 9 is a waveform diagram showing the relationship among the current level change signal CLCS, the second reference voltage VREF2, the supply voltage VOUT and the current I_{LED} flowing through the LEDs when the digital compensation block 122 does not include the memory & selection unit 550.

FIG. 9 shows variations in the second reference voltage VREF2 and the supply voltage VOUT generated using the second reference voltage VREF2 when currents of 20 mA and 40 mA flow through the LEDs according to the current level change signal CLCS. It is assumed that current of 20 mA flows if the current level change signal CLCS is logic low, and current of 40 mA flows if the current level change signal CLCS is logic high.

If the current level change signal CLCS is logic low, 20 mA flows through the LEDs, and the second reference voltage VREF2 and the supply voltage VOUT become 30V.

At a rising edge at which the current level change signal CLCS transits from logic low to logic high, the second reference voltage VREF2 increases stepwise, and the supply voltage VOUT also increases with a predetermined gradient to reach 35V at which 40 mA flows through the LEDs.

At a falling edge at which the current level change signal CLCS transits from logic high to logic low, the second reference voltage VREF2 decreases stepwise, and the supply voltage VOUT also decreases with a predetermined gradient to be 30V at which 20 mA flows through the LEDs.

If it is ideal that the supply voltage VOUT that determines the size of current flowing through the LEDs is abruptly changed according to a variation in the current level change signal CLCS, it is not desirable that the supply voltage VOUT varies with a predetermined gradient, as shown in FIG. 9.

Accordingly, according to an exemplary embodiment, the memory & selection unit 550 is added to the digital compensation block 122.

FIG. 10 is a waveform diagram showing the relationship among the current level conversion signal CLCS, the second reference voltage VREF2, the supply voltage VOUT, and the current I_{LED} flowing through the LEDs when the digital compensation block 122 includes the memory & selection unit 550.

Referring to FIG. 10, when the digital compensation block 122 includes the memory & selection unit 550, the first register 551 and the second register 552, shown in FIG. 5, store two supply voltages VOUT during an initial single period of the current level change signal CLCS, and then, the adder 530 immediately uses a corresponding voltage among the stored supply voltages after the initial period. Accordingly, the supply voltage VOUT is rapidly changed, and thus the current I_{LED} flowing through the LEDs also rapidly varies.

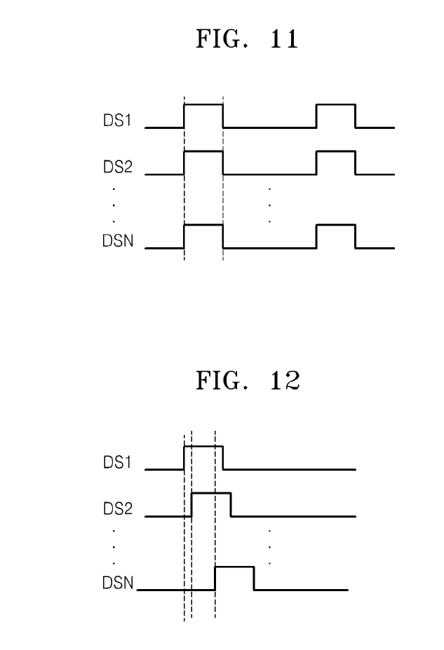

FIGS. 11 and 12 show the relationship between the N dimming voltage signals DS_1 through DS_N.

The N dimming voltage signals DS_1 through DS_N may have the same phase, as shown in FIG. 11, and may have different phases, as shown in FIG. 12.

It is desirable to use the N dimming voltage signals DS_1 through DS_N having the same phase, as shown in FIG. 11, to simultaneously operate all the N LED channels CH1 through CHN and it is desirable to use the N dimming voltage signals DS_1 through DS_N having different phases, as shown in FIG. 12, to operate the respective channels at predetermined intervals. Particularly, the waveform shown in FIG. 12 may be usefully used to perform local dimming for selectively operating the N LED channels CH1 through CHN.

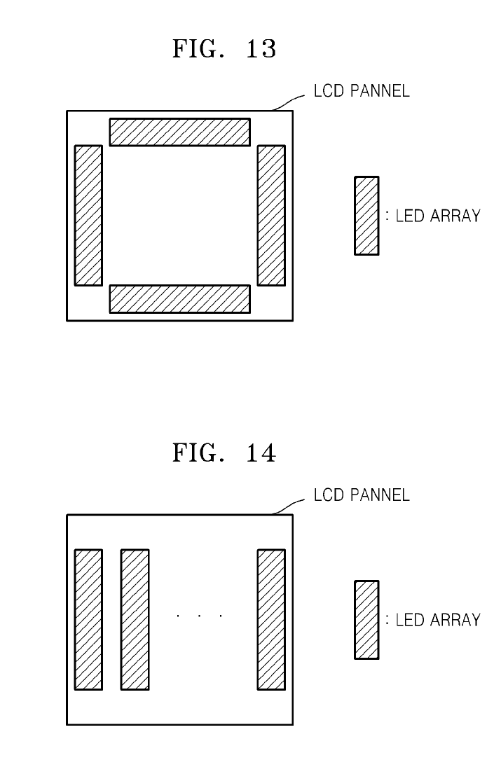

FIG. 13 illustrates an edge type LCD and FIG. 14 illustrates a direct type LCD according to an exemplary embodiment.

The N dimming voltage signals DS_1 through DS_N shown in FIGS. 11 and 12 may be used according to the edge type LCD in which LEDs are arranged close to the edge of the LCD and the direct type LCD in which LEDs are arranged in parallel with each other in a direction across the backside of the LCD.

As described above, the multi-channel LED driving circuit according to the exemplary embodiments converts a result obtained by comparing analog channel voltages to an analog combination voltage into a digital signal through a 1.5 bit analog-to-digital converter, and processes the digital signal to determine the supply voltage VOUT, and thus influence of noise can be minimized as compared to a conventional technique of processing an analog signal. In the case of an operational amplifier used to process analog signals, the operational amplifier is required to be designed in consideration of frequency response characteristics according to the frequency of an analog signal. However, there is no need for the multi-channel LED driving circuit according to the exemplary embodiments to be designed in a complex manner.

Moreover, the compensation cycle of the supply voltage VOUT is not limited to a single period of a dimming signal and the supply voltage VOUT is compensated once per two periods or more of the dimming signal, and thus, the supply voltage VOUT may be used in a wide application range.

In addition, the memory & selection unit 550 is added to the digital compensation block 122 to rapidly change the current supplied to LEDs.

While the inventive concept has been particularly shown and described with reference to exemplary embodiments thereof, it will be understood that various changes in form and details may be made therein without departing from the spirit and scope of the following claims.

What is claimed is:

1. A multi-channel light-emitting diode (LED) driving circuit comprising:
an LED array comprising N LED channels, wherein N is an integer equal to or greater than one (1), each of which comprises a plurality of LEDs connected in series, to one end of each of which a supply voltage is input, and the other end of which is connected to N current drivers, respectively;
a dynamic headroom control block which compares N channel voltages of common nodes of the N LED channels and the N current drivers with combination voltages of a first reference voltage and a hysteresis voltage, and generates a second reference voltage in response to at least one dimming signal that defines a time period during which a predetermined current flows to the N current drivers through the N LED channels; and
a direct current to direct current (DC-DC) converter which generates the supply voltage corresponding to the second reference voltage.

2. The multi-channel LED driving circuit of claim 1, wherein the dynamic headroom control block comprises:
a compare block which compares the N channel voltages with the combination voltages, and delays the comparison result by a predetermined time in response to a corresponding dimming signal to generate a delayed latch signal;
a digital compensation block which compensates for the delayed latch signal according to a logic state of the delayed latch signal in response to the corresponding dimming signal to generate a compensated signal; and
a digital-to-analog converter which converts the compensated signal that is a digital signal to generate the second reference signal that is an analog signal.

3. The multi-channel LED driving circuit of claim 2, wherein the compare block comprises:
an analog-to-digital converter block which compares the N channel voltages that are analog signals with the combination signals that are analog signals, and generates 2N compare signals that are digital signals; and
a delayed latch block which delays the 2N compare signals by a predetermined time in response to the corresponding dimming signal to generate the delayed latch signal.

4. The multi-channel LED driving circuit of claim 3, wherein the analog-to-digital converter block comprises N 1.5-bit analog-to-digital converters respectively comparing the N channel voltages with the combination voltages to generate first compare signals and second compare signals,
wherein each of the 1.5-bit analog-to-digital converters comprises:
a first comparator which generates the first compare signal corresponding to a difference between a first combination signal, corresponding to a sum of the first reference voltage and the hysteresis voltage, which is applied to a first input terminal thereof, and a corresponding channel voltage applied to a second input terminal thereof; and
a second comparator which generates the second compare signal corresponding to a difference between a second combination signal, corresponding to a difference between the first reference voltage and the hysteresis voltage, which is applied to a second input terminal thereof, and the corresponding channel voltage applied to a first input terminal thereof.

5. The multi-channel LED driving circuit of claim 4,
wherein the first compare signal output from the 1.5-bit analog-to-digital converter becomes logic high if the corresponding channel voltage is higher than the first combination voltage,
wherein the second compare signal output from the 1.5-bit analog-to-digital converter becomes logic high if the corresponding channel voltage is lower than the second combination voltage, and
wherein both the first and second compare signals output from the 1.5-bit analog-to-digital converter become logic low if the corresponding channel voltage corresponds to a value between the first combination voltage and the second combination voltage.

6. The multi-channel LED driving circuit of claim 4,
wherein the delayed latch block comprises N delayed latch circuits respectively delaying the first compare signals and the second compare signals respectively output from the N 1.5-bit analog-to-digital converters from rising edges or falling edges of corresponding dimming signals to generate first latch signals and second latch signals, and
wherein the delayed latch signal corresponds to a sum of 2N latch signals output from the N delayed latch circuits.

7. The multi-channel LED driving circuit of claim 6, wherein the digital compensation block comprises:
a decision logic circuit which generates a compensation decision signal using the corresponding dimming signals and the delayed latch signal;
a coefficient decision unit which generates a coefficient signal corresponding to the compensation decision signal;
an adder which adds the coefficient signal to the compensated signal; and
an output register which stores a signal output from the adder and outputs the compensated signal.

8. The multi-channel LED driving circuit of claim 7, wherein the coefficient decision unit comprises:
a first coefficient generating unit including a first coefficient storage unit which stores a first coefficient one (1) and a sign selecting unit which selects a sign of the first coefficient one (1), in response to the compensation decision signal;
a second coefficient storage unit which stores a second coefficient zero (0); and
a multiplexer which selects one of the first coefficient and the second coefficient, respectively, output from the first coefficient generating unit and the second coefficient storage unit, and outputs the selected coefficient.

9. The multi-channel LED driving circuit of claim 8,
wherein the compensation decision signal instructs the first coefficient to be minus one (−1) if all the first compare signals output from the N delayed latch circuits are logic high,
wherein the compensation decision signal instructs the first coefficient to be one (1) when at least one of the second compare signals output from the N delayed latch circuits is logic high, and
wherein the compensation decision signal instructs the first coefficient to be zero (0) in the other cases.

10. The multi-channel LED driving circuit of claim 7, wherein the dynamic headroom control block receives a compensation control signal and the decision logic circuit controls a cycle of generating the compensation decision signal according to a cycle of the corresponding dimming signals in response to the compensation control signal.

11. The multi-channel LED driving circuit of claim 6, wherein the digital compensation block receives a current level change signal, the digital compensation block comprising:
a decision logic circuit which generates the compensation decision signal using the corresponding dimming signals and the delayed latch signal;
a coefficient decision unit which generates a coefficient corresponding to the compensation decision unit;
an adder which adds the coefficient to the compensated signal;
an output register which stores a signal output from the adder and outputs the compensated signal; and
a memory and selection unit which stores the compensated signal in response to the current level change signal, and transmits to the adder a selected compensated signal selected from the stored compensated signal and the compensated signal.

12. The multi-channel LED driving circuit of claim 11, wherein the coefficient decision unit comprises:
a first constant generator including a first constant storage unit which stores a first constant one (1) and a sign selector which selects a sign of the first constant one (1), in response to the compensation decision signal;
a second constant storage unit which stores a constant zero (0); and
a multiplexer which selects one of the first constant and the second constant, respectively, output from the first constant generator and the second constant storage unit, in response to the compensation decision signal, and outputs the selected constant.

13. The multi-channel LED driving circuit of claim 11, wherein the memory and selection unit comprises:
a first register which stores a compensated signal corresponding to a first current level signal among compensated signals output from the output register, in response to the current level change signal;
a second register which stores a compensated signal corresponding to a second current level signal among the compensated signals output from the output register, in response to the current level change signal; and
a multiplexer which selects one of the compensated signals, respectively, stored in the first and second registers and the compensated signal output from the output register as the selected compensated signal, in response to the current level change signal.

14. The multi-channel LED driving circuit of claim 13, wherein the compensated signal is stored in the first register or the second register at an initial falling edge of the current level change signal, and the stored compensated signal is transmitted to the multiplexer at every rising edge following a second rising edge.

15. The multi-channel LED driving circuit of claim 11,
wherein the compensation decision signal instructs the coefficient to be minus one (−1) if all the first compare signals output from the delayed latch circuits are logic high,
wherein the compensation decision signal instructs the coefficient to be one (1) if at least one of the second compare signals output from the delayed latch circuits is logic high, and
wherein the compensation decision signal instructs the coefficient to be zero (0) in the other cases.

16. A method for controlling a supply voltage of a multi-channel light-emitting diode (LED) driving circuit comprising N LED channels, where N is an integer equal to or greater than one (1), each of which comprises a plurality of LEDs connected in series, to one end of which a supply voltage is input, and the other end of which is connected to N current drivers, respectively, the method comprising:
deciding a first reference voltage and a hysteresis voltage and receiving N channel voltages of common nodes of N LED channels and the N current drivers corresponding to the N LED channels, respectively;
comparing the N channel voltages with a first combination voltage defined as a sum of the first reference voltage and the hysteresis voltage and a second combination voltage defined as a difference between the first reference voltage and the hysteresis voltage;
maintaining, increasing, or decreasing the supply voltage according to a result of the comparing.

17. The method of claim 16, wherein the comparing the N channel voltages with the first and second combination voltages comprises:
determining whether the N channel voltages are higher than the first combination voltage;
assigning logic high to N first compare signals if the N channel voltages are higher than the first combination voltage, and assigning logic low to the first compare signals if the N channel voltages are lower than the first combination voltage;
determining whether the N channel voltages are lower than the second combination voltage;
assigning logic high to N second compare signals if the N channel voltages are lower than the second combination voltage, and assigning logic low to the second compare signals if the N channel voltages are higher than the second combination voltage.

18. The method of claim 17, wherein the maintaining, increasing, or decreasing the supply voltage comprises:
determining whether all the N first compare signals are assigned logic high;
determining whether at least one of the N second compare signals is assigned logic high;
decreasing the supply voltage if it is determined that all the N first compare signals are assigned logic high, increasing the supply voltage if it is determined that at least one of the N second compare signal is assigned logic high, and maintaining a current level of the supply voltage in the other cases.

19. The method of claim 18, wherein the deciding the first reference voltage and the hysteresis voltage, the comparing the N channel voltages with the first and combination voltages, and one of the decreasing, increasing and maintaining the supply voltage are repeated after the one of the decreasing, increasing maintaining the supply voltage.

20. A multi-channel system performing the method of claim 16.
